(19) United States
(12) Patent Application Publication
(10) Pub. No.: US 2006/0234097 A1
(43) Pub. Date: Oct. 19, 2006

(54) Self-healing membrane for a fuel cell

(75) Inventors: Gustav Boehm, Ueberlingen (DE); Florian Finsterwalder, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DAIMLERCHRYSLER AG, Epplestr (DE)

(21) Appl. No.: 10/549,547

(22) PCT Filed: Mar. 8, 2004
(86) PCT No.: PCT/EP04/02330

§ 371 Date: May 15, 2006

(30) Foreign Application Priority Data
Mar. 18, 2003 (DE) 103 12 029.7

(51) Int. Cl. H01M 8/10

(52) U.S. Cl. 429/30; 429/33

(57) ABSTRACT

A self-healing membrane, especially for using in PEM fuel cells. The membrane comprises at least one porous material which is not ion-conductive and at least one polymer, ion-conductive electrolyte which has a higher melting point or decomposition point that the porous material which is not ion-conductive. If a hole, crack or the like forms in the membrane, the porous material which is not ion-conductive melts due to the temperature rise occurring at the leaking point, before the polymer, ion-conductive electrolyte melts or decomposes and seals the membrane at this point. The inventive membrane heals occurring defects itself in this way, and is thus self-healing.

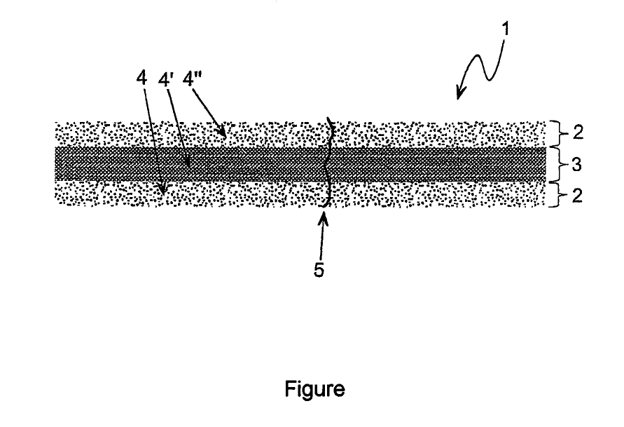

The invention relates to a self-healing membrane for a fuel cell and to its use in membrane electrode assemblies for fuel cells.

A fuel cell is an apparatus for converting energy which is able to very efficiently convert chemical energy stored in a fuel into electrical energy. At present, the development of fuel cells is progressing in leaps and bounds. Reasons for this include, in addition to the abovementioned efficiency of fuel cells, their potential for limiting the anthropogenic greenhouse effect and extending the life of energy carrier reserves, as well as their low emissions of pollutants and noise. Furthermore, fuel cells can generate reliable, high-quality electric current.

Fuel cells with polymer electrolyte membranes, also known as proton exchange membranes, are particularly suitable for certain applications, e.g. in the mobile sector or if very small fuel cells are required. One reason for this is that fuel cells of this type have good dynamic properties, a good cycle stability and can be operated at low temperatures. The latter factor is of interest for military applications, among others, since fuel cells of this type are very difficult to locate using thermal imaging cameras, for example.

The basic structure of a typical polymer electrolyte membrane fuel cell—PEMFC for short—is as follows. The PEMFC includes a membrane electrode assembly—MEA for short—which is composed of an anode, a cathode and a polymer electrolyte membrane—PEM for short—arranged between the anode and cathode. For its part, the MEA is in turn arranged between two separator plates, one separator plate having passages for the distribution of fuel and the other separator plate having passages for the distribution of oxidizing agent, and the passages facing the MEA. The electrodes, anode and cathode, are generally designed as gas diffusion electrodes—GDE for short. They have the function of tapping off the current generated during the electrochemical reaction (e.g. 2H₂+O₂→2H₂O) and of allowing the reaction materials, starting materials and products, to diffuse through. A GDE comprises at least one gas diffusion layer—GDL for short—and a catalyst layer, which faces the PEM and at which the electrochemical reaction takes place. One purpose of the PEM is to pass protons from the anode to the cathode and to fluidically and electrically separate the anode space from the cathode space. This is intended to prevent the reaction materials from mixing and to prevent electrical short-circuits.

A PEMFC can generate electric current with a high power at relatively low operating temperatures. Real fuel cells are generally stacked to form what are known as fuel cell stacks—or just stacks for short—in order to achieve a high discharge of power, in which case bipolar separator plates, known as bipolar plates, are used instead of the monopolar separator plates, whereas monopolar separator plates are used only as end plates of the stack.

Reaction materials used are fuels and oxidizing agents. The reaction materials used are generally in gas form, e.g. H₂ or an H₂-containing gas (e.g. reformate gas) as fuel and O₂ or an O₂-containing gas (e.g. air) as oxidizing agent. The term reaction materials is to be understood as meaning all substances which participate in the electrochemical reaction, i.e. including the reaction products, such as for example H₂O.

Despite their advantages, in particular for mobile applications, PEMFCs also have certain drawbacks, most of their drawbacks being attributable to the PEM. By way of example, a common feature of most conventional PEMs is that they have a low mechanical, thermal and/or chemical stability, a reduced conductivity at high temperatures (>80° C.) and/or if they are not well wetted.

For example, the service life of modern PEMFCs, in particular under conditions which are of relevance in vehicles, is often limited by the PEM. A frequent cause of total failure of PEMFCs is, for example, that the PEM, on account of the loads which occur during operation, production and/or installation in the fuel cell, suffers damage and/or leaks. Even small holes or cracks or the like can lead to internal electrical short-circuits and to fuel penetrating into the cathode space or oxidizing agent into the anode space, in which case the reaction materials may under adverse circumstances react directly with one another. Since both processes produce large amounts of heat at the location of the leak in the PEM (ohmic heat loss resulting from the short-circuit, heat of reaction resulting from the direct chemical reaction), the PEMs may burn through at these “hot spots”, which leads to total failure of the fuel cell. The situation is even worse if hydrogen and oxygen are used as reaction materials and mixed with one another as a result of a leak in the PEM, to produce a hydrogen-oxygen gas mixture. Under unfavorable circumstances, this can lead to a serious explosion and therefore to total failure of some or all the fuel cells in a stack. Since, as has been mentioned, existing leaks release large amounts of heat, which increases the size of the leaks by burning through the PEM, which leads to even more heat being released, in conventional PEMs, once leaks have formed, they generally increase in size in a self-accelerating manner.

Standard measures aimed at combating these problems are based on avoiding leaks in the PEM, e.g. by strict quality control during production of the membranes, by optimized dissipation of heat within an MEA equipped with a PEM of this type, and/or by mechanically stabilized or protected PEMs. However, all these measures have the drawback of being purely preventive and not being suitable to counteract leaks which occur nevertheless, with all their negative consequences.

It would be desirable to have available a membrane which automatically seals itself again in the event of a leak forming.

The field of lithium batteries has disclosed membranes which, although not inherently fluid-tight, automatically seal themselves in the event of hazardous operating situations. For example, EP 951 080 B1 (Celgard) has disclosed a membrane formed from three layers, the first and third layers being strength layers, between which is arranged a shut-down layer which is microporous. The membrane contains an electrolyte, although this is not defined in more detail. However, it can be assumed that this a liquid or gel electrolyte which is typical for Li batteries and can move within the micropores. The shutdown layer melts at a temperature of just 124° C. or even below, thereby closing up the pores in the membrane and causing the flow of Li ions from the anode to the cathode to be interrupted, so that the electric circuit is broken. As a result, the entire lithium battery is shut down before the melting point of lithium and/or the ignition point of lithium with the electrolyte is reached. This prevents catastrophic thermal collapse of the Li battery. However, membranes of this type are unsuitable for fuel cells, on account of the fact that they are not leaktight.

International application WO 96/28242 (Gore) has disclosed a composite membrane which comprises a membrane of expanded polytetrafluoroethylene (ePTFE) and an ion exchange material. The ePTFE has a microstructure of polymer fibers and is impregnated with the ion exchange material in such a way that the internal volume of the membrane is closed off in such a manner as to be inaccessible. The membrane has a Gurley number of greater than 10 000 s. This document does not disclose shutdown operations or automatic sealing in the event of leaks occurring.

Working on the basis of this prior art, it is an object of the present invention to provide a fluid-tight membrane which is suitable for use in a fuel cell and which automatically seals leaks if any occur.

A further object of the present invention is to propose a use for an automatically sealing membrane.

Accordingly, a first subject of the present invention is a membrane for a fuel cell comprising at least one porous, non-ion-conducting material and at least one ion-conducting electrolyte, which is arranged in the pores and fills them in a fluid-tight manner. According to the invention, the at least one ion-conducting electrolyte is a polymeric electrolyte which has a higher melting point or decomposition point than the porous, non-ion-conducting material.

A porous material is to be understood as meaning a material whereof the pores are at least in some cases continuous. Pores of this type fluidically connect two opposite surfaces, in particular main surfaces, to one another. The sizes of the pores are in this case in the range from 0.1 to 100 μm (microporosity).

The ion-conducting electrolyte is preferably a proton-conducting electrolyte.

The polymeric, ion-conducting electrolyte fills the pores in a fluid-tight manner. The term fluids is to be understood as meaning both gases and liquids. In the context of the present invention, the term “fluid-tight” is to be understood as meaning that it is substantially impossible for fluids to pass through the membrane according to the invention. This is to be understood in particular as meaning Gurley numbers of 5000 s and above.

If the porous, non-ion-conducting material and/or the polymeric, ion-conducting electrolyte do not have a sudden melting point, but rather a melting range, as is usually the case for example with polymers, there is no overlap between the melting ranges or melting points. The melting range or melting point of the polymeric, ion-conducting electrolyte, in accordance with the invention, is always higher than the melting range or melting point of the porous, non-ion-conducting material. In this context, it is preferable for at least any melting range of the polymeric, ion-conducting electrolyte to be as narrow as possible, in particular for the melting range to amount to 5° C. or less.

Furthermore, it is often the case that a polymeric, ion-conducting electrolyte decomposes before it melts, i.e. it does not have a melting point, but rather a decomposition point. In this case, the statements which have been made in connection with the melting point or melting range apply in a corresponding way. In other words, it is then the case that the decomposition point of the polymeric, ion-conducting electrolyte, in accordance with the invention, lies at higher temperatures than the melting point or melting range of the porous, non-ion-conducting material.

Unless stated otherwise, in the context of the present invention the term “melting point” always also encompasses the term “melting range” and also, with regard to the polymeric, ion-conducting electrolyte, the “decomposition point”.

It is also preferable if the porous, non-ion-conducting material melts without decomposition, and moreover is chemically stable under the conditions prevailing in a PEMFC when the latter is used as intended.

The membrane according to the invention is fluid-tight and eminently suitable for use in a fuel cell. If a leak (e.g. a hole, a crack or the like) occurs in the membrane, the porous, non-ion-conducting material melts as a result of the temperature rise which occurs at the location of the leak before the polymeric, ion-conducting electrolyte melts or decomposes, and seals the membrane at this point. As a result, the ionic conductivity of the membrane is also eliminated at this point, so that a reaction and also evolution of heat can no longer take place there. In this way, the membrane according to the invention self-heals defects which occur; in this respect, it is self-healing.

Surprisingly, it has been discovered that the self-healing mechanism described occurs only in the case of membranes in which the porous, non-ion-conducting material melts before the polymeric, ion-conducting electrolyte melts or decomposes. The self-healing mechanism was not found in membranes in which the porous, non-ion-conducting material and the polymeric, ion-conducting electrolyte melt simultaneously (or the polymeric, ion-conducting electrolyte decomposes at the same time as the porous, non-ion-conducting material melts) or in which the polymeric, ion-conducting electrolyte melts or decomposes before the porous, non-ion-conducting material.

Unlike in the case of the known membranes with a shutdown mechanism, the membrane according to the invention is not completely shut down, but rather is only shut down at points, specifically only at the locations at which a leak occurs. Consequently, the fuel cell can continue to operate, even though its membrane has lost its ion conductivity after automatic sealing at one or more locations, until, in extreme cases, the complete membrane is sealed off. This lengthens the service life of the fuel cell considerably.

Furthermore, a fuel cell equipped with a membrane according to the invention also has an improved operating reliability, since accidents caused by hydrogen-oxygen gas explosions are virtually ruled out.

A further advantage of the membranes according to the invention is that the outlay involved in quality control can be reduced during production of the membranes according to the invention and their installation in MEAs, since any leaks which occur when a fuel cell equipped with a membrane according to the invention is being operated as intended are automatically healed.

The ability of the membranes according to the invention to automatically close up any leaks which occur is not unlimited, but rather depends on the size of the leak. If the hole or crack is too large, it may be impossible for the membrane to automatically close up again. However, it has been found that by far the majority of leaks which can be observed in the membranes of PEMFCs are generally so small immediately after they are formed that they can easily be closed up by the self-healing mechanism of the membranes according to the invention. Leaks which are so large that they can no longer automatically be closed up generally only occur if they are imparted to the membrane intentionally or by very unskilled handling. By way of example, intentionally produced holes which could no longer be closed up had a surface area of approximately 0.1 mm2 or more, and intentionally produced cracks which could no longer be closed up had a length of approximately 1 mm or more.

In a preferred embodiment of the membrane according to the invention, the polymeric, ion-conducting electrolyte has a melting point or decomposition point which is at least 15° C. higher than the porous, non-ion-conducting material, preferably a melting point or decomposition point which is 20 to 80° C. higher. This has the advantage that the melting points or the melting point and the decomposition point of the porous, non-ion-conducting material and of the polymeric, ion-conducting electrolyte are clearly separated from one another. Membranes of this type have a particularly good self-healing capacity.

In this context, it is also preferable if the porous, non-ion-conducting material has a melting point in the range from 125 to 250° C., preferably in the range from 130 to 180° C. This makes it possible to ensures that the porous, non-ion-conducting material does not melt at temperatures which are either too low or too high. If the porous, non-ion-conducting material were to melt at temperatures which are too low, the service life of the membrane would be unnecessarily reduced; if the porous, non-ion-conducting material were only to melt at temperatures which are too high, there is an increased risk of the hot spot becoming too large and of the melted region of the membrane, which is no longer ionically conductive, becoming unnecessarily large, which unnecessarily entails a considerable reduction in the performance of the membrane.

In this context, preferably organic polymers, in particular thermoplastics, have proven suitable materials for the porous, non-ion-conducting material. Suitable materials include in particular polyolefins, such as for example polyethylenes and propylenes.

Other suitable materials includes in particular polystyrenes, polyvinylidene fluorides, polysulfones, polyvinyl chlorides, polyvinyl fluorides, polyamides, polyethylene terephthalates, polyoxymethylenes and polycarbonates.

Other suitable materials also include in particular copolymers, such as for example polytetrafluoroethylene/polystyrene copolymers and polyphenylene oxide/polystyrene copolymers.

Furthermore, it is also possible to use mixtures, copolymers or combinations of the abovementioned polymers. The term “combination” is to be understood as meaning that two or more of the abovementioned polymers, or a mixture thereof, are present together.

At this point, it should also be mentioned that the melting point of polymers is known to be dependent on their chain length or chain length distribution. However, it will not be difficult for the person skilled in the art to select from among the abovementioned polymers those which have a suitable chain length distribution and a suitable melting point or melting range.

In particular ionomers which include acidic groups, such as for example sulfonic acid, phosphonic acid and/or carboxylic acid groups, have proven to be suitable materials for the polymeric, ion-conducting electrolyte. Suitable examples include polyperfluorocarbosulfonic acids, sulfonated polyethylene oxides, polybenzimidazoles/phosphoric acid blends, sulfonated polysulfones, sulfonated polyether sulfones, sulfonated polystyrenes, sulfonated perfluorovinylene ethers, sulfonated polyether ketones, sulfonated polyolefins and mixtures or copolymers thereof. Among these, Nafion® (DuPont), Flemion® (Asahi Glass), Aciplex® (Asahi Kasei) and Neosepta-F® (Tokuyama Soda) are particularly suitable.

If, as in the present invention, a combination of two or more materials which are present next to one another is to be fluid-tight, it is necessary for these materials to be compatible with one another, i.e. for it to be impossible for them to become detached from one another under the conditions of intended use, during production and during installation, since this could give rise to leaks. This requires careful selection or matching of the two or more materials to one another.

In particular polyvinylidene fluoride and Nafion®, polypropylene and Nafion®, and polyethylene and Flemion® have proven to be suitable combinations for the porous, non-ion-conducting material and the polymeric, ion-conducting electrolyte.

Furthermore, it is proven advantageous if the porous, non-ion-conducting material has a structure comprising one or more layers. This has the advantage that one or more of these layers, but not all of them, can be designed as reinforcing or supporting layers which impart dimensional stability to the membrane if a porous, non-ion-conducting layer—referred to as self-sealing layer to distinguish it from the reinforcing or supporting layers—melts as intended. In this case, the reinforcing or supporting layers preferably have a higher melting point than the self-sealing layer, and in particular also a lower melting point than the polymeric, ion-conducting electrolyte.

A membrane in which the porous, non-ion-conducting material has a structure comprising three layers is particularly advantageous in this context, since, for example, more layers have a deleterious effect on the membrane production costs. The two outer layers may in this case, for example, be designed as reinforceable supporting layers, whereas the layer arranged between them may be designed as a self-sealing layer.

In a preferred embodiment of the present invention, the pores in the porous, non-ion-conducting material are formed by the polymer fibers of the material. In another, likewise preferred embodiment of the present invention, polymer foams are used, with the pores formed by the spaces between the foam bubbles.

A second subject of the present invention is the use of the membrane according to the invention as disclosed above in membrane electrode assemblies (MEAs) for electrochemical cells, preferably for fuel cells.

An MEA which is equipped with a membrane of this type has the advantage that it is not completely shut down in the event of a leak occurring in its membrane, but rather is merely shut down in punctiform fashion at the location of the leak. As a result, its service life is lengthened. Furthermore, it has an improved operational reliability, in particular if it is used in fuel cells, since leaks which occur in its membrane are automatically closed up, thereby preventing the undesirable mixing of fuel and oxidizing agent, which in certain cases can give rise to dangerous hydrogen-oxygen gas mixtures. The MEA according to the invention can also be produced with reduced demands on quality, making it less expensive to produce.

The invention is explained in more detail below with reference to a figure. The figure diagrammatically depicts a section through a membrane (1) according to the invention. The membrane (1) has three layers (2), (3) of a porous, non-ion-conducting material. In this example, the two outer layers (2) substantially comprise polyvinylidene fluoride and form reinforcing or supporting layers. In this example, the inner layer (3) substantially comprises polypropylene and forms a self-sealing layer. The three porous layers (2), (3) are in this example filled with Nafion® as polymeric, ion-conducting electrolyte which is arranged in the pores (4), (4′), (4″) in the porous, non-ion-conducting material (polyvinylidene fluoride and polypropylene); in the figure, only the pores denoted by (4), (4′) and (4″) are indicated, as representatives of all the pores, for the sake of clarity.

In this example, the Nafion® has a decomposition point of approximately 200° C., the polypropylene has a melting range from 160 to 165° C., and the polyvinylidene fluoride has a melting point of approximately 174° C. (5) indicates a leak, in this example a crack. As a result of the crack (5), the material is heated in this vicinity to an extent which is such that the self-sealing layer (3) melts and the material of the self-sealing layer (3), as mentioned above polypropylene, flows into the crack (5) and seals it (self-healing mechanism). During this process, the two reinforcing or supporting layers (2) help the membrane to maintain its dimensional stability. However, in the event of strong temperature rises, the reinforcing or supporting layers (2) may also melt and assist with the automatic sealing of the crack (5). After the crack (5) has been closed up by the melting phenomenon, ion or proton transport through the membrane is suppressed at this location, with the result that the electrochemical reaction of the electrochemical cell in which the membrane is installed stops and the membrane cools down and thus sets at this location. Consequently, it is not possible for the membrane to burn through at this location. However, the electrochemical reaction can continue at all the locations which are not affected by the crack, so that although the membrane loses part of its power as a result of the sealed-off location (5), it can overall continue to operate.

The production of a membrane of this type will be explained below by way of example on the basis of a three-layer polypropylene/polyethylene/polypropylene membrane. A three-layer membrane sandwich (Celgard) comprising porous polypropylene/polyethylene/polypropylene with a thickness of 25 μm is placed in a saturated solution of Nafion-1100® (DuPont) in isopropanol for 1 h and then dried for 24 h at 50° C. Then, a spray coat of Nafion® (DuPont) was additionally (optionally) applied to both main surfaces.

Good membranes produced by this process are from 5 to 200 μm thick; the thickness depends primarily on the thickness of the membrane sandwich used.

This membrane was then coated with a catalyst ink (Pt) on both main surfaces by processes known to the person skilled in the art and pressed together with electrodes to form an MEA, likewise using processes known to the person skilled in the art.

1-7. (canceled)

8. A membrane for a fuel cell which comprises:
at least one porous, non-ion-conducting material; and
at least one ion-conducting electrolyte arranged and configured to fill the pores of the at least one porous, non-ion-conducting material;
the at least one ion-conducting electrolyte comprising a polymeric electrolyte having a characteristic selected from the group consisting of a higher melting point and a higher decomposition point relative to the melting point or decomposition point of the porous, non-ion-conducting material.

9. The membrane of claim 8, wherein the polymeric, ion-conducting electrolyte has a characteristic selected from the group consisting of a higher melting point and a higher decomposition point, which is at least 15° C. higher than the porous, non-ion-conducting material.

10. The membrane of claim 9, wherein the polymeric, ion-conducting electrolyte has a characteristic selected from the group consisting of a higher melting point and a higher decomposition point, which is at least 20 to 80° C. higher than the porous, non-ion-conducting material.

11. The membrane of claim 8, wherein the porous, non-ion-conducting material has a melting point in the range from 125 to 250° C.

12. The membrane of claim 11, wherein the porous, non-ion-conducting material has a melting point in the range from 130 to 180° C.

13. The membrane of claim 8, wherein the porous, non-ion-conducting material comprises an organic polymer.

14. The membrane of claim 13, wherein the porous, non-ion-conducting material comprises a thermoplastic selected from the group consisting of a polyolefin, polystyrene, polyvinylidene fluoride, polysulfone, polyvinyl chloride, polyvinyl fluoride, polyamide, polyethylene terephthalate, polyoxymethylene, polycarbonate and mixtures, copolymers and combinations thereof.

15. The membrane of claim 8, wherein the polymeric, ion-conducting electrolyte substantially comprises an ionomer selected from the group consisting of sulfonic acid, phosphonic acid, carboxylic acid groups, polyperfluorocarbosulfonic acid, sulfonated polyethylene oxide, polybenzimidazole/phosphoric acid blend, sulfonated polysulfone, sulfonated polyether sulfone, sulfonated polystyrene, sulfonated perfluorovinylene ether, sulfonated polyether ketone, sulfonated polyolefin and mixtures and copolymers thereof.

16. The membrane of claim 8, wherein the porous, non-ion-conducting material comprises a layered structure.

17. The membrane of claim 16 wherein the layered structure comprises three layers.

18. A method for using an automatically sealing membrane, comprising the steps of:
providing a membrane comprising: at least one porous, non-ion-conducting material; and
at least one ion-conducting electrolyte arranged and configured to fill the pores of the at least one porous, non-ion-conducting material;
the at least one ion-conducting electrolyte comprising a polymeric electrolyte having a characteristic selected from the group consisting of a higher melting point and a higher decomposition point relative to the melting point or decomposition point of the porous, non-ion-conducting material; and
using the membrane provided in the previous step in a membrane electrode assembly (MEA) for electrochemical cells.

19. The method of claim 18, wherein the MEA comprises a fuel cell.
